(19) United States
(12) Patent Application Publication
(10) Pub. No.: US 2026/0146004 A1
(43) Pub. Date: May 28, 2026

(54) WEARABLE ARTICLES USING EARTHEN MATERIALS

(71) Applicant: The Trustees of Columbia University in the City of New York, New York, NY (US)

(72) Inventors: RACHEL LOLA BEN-ALON, New York, NY (US); PENMAI CHONGTOUA, Brooklyn, NY (US)

(73) Assignee: The Trustees of Columbia University in the City of New York, New York, NY (US)

(21) Appl. No.: 19/401,999

(22) Filed: Nov. 26, 2025

Related U.S. Application Data
(60) Provisional application No. 63/725,192, filed on Nov. 26, 2024.

(51) Int. Cl. C04B 33/04; A41D 1/22; A41D 31/00; B28B 1/14; B28B 17/02; C04B 33/13; C04B 33/30; C04B 35/626

(52) U.S. Cl. CPC C04B 33/04; A41D 1/22; A41D 31/00; B28B 1/14; B28B 17/026; C04B 33/1305; C04B 33/30; C04B 35/6269; C04B 2235/349; C04B 2235/6567

(57) ABSTRACT

Garments are constructed utilizing wearable textile pieces composed of earth- and bio-based materials. The wearable textiles include 65% clay-rich raw soil, with the balance being bio-based based polymers such as cornstarch, glycerin, cellulose, gelatin, alginate, agar, or combinations thereof, and fiber additives such as wheat straw, paper waste, or combinations thereof. The solid components are mixed with water or vinegar and heated to a predetermined temperature before being cast and cured in molds having the desired shape, e.g., a sheet of soil-based fabric, a shape corresponding to a portion of a garment, etc. The textiles can be fabricated with a thickness between about 0.1 cm and about 2 cm, and further combined to form garments via processes such as laser-cutting, embroidery, or machine sewing. These garments can be composed entirely of these wearable textiles, integrating raw soil with naturally occurring bio-based plastics to create clothing that is flexible, lightweight and biodegradable.

### CROSS REFERENCE TO RELATED APPLICATION(S)

This application claims the benefit of U.S. Provisional Application No. 63/725,192, filed Nov. 26, 2024, which is incorporated by reference as if disclosed herein in its entirety.

### BACKGROUND

Earthen materials have been fabricated and applied in design practices throughout history and across global geographies. They have been evidenced across different disciplines of traditional construction, playing an inseparable role in the arch of human ingenuity and resourcefulness. Earthen building technologies have been evidenced in European construction dating as far back as the 12th century. Notable examples include a 16th century building in Broadhembury, Devon, constructed almost entirely with cob.

In addition to the use of earthen materials as a structural material, they have also been used as a finish surface. Examples of earthen plaster derived from soils with at least 20% of clay minerals can be shown in Sudano-Sahelian architecture across the western and eastern coasts of Africa below the Saharan desert, characterized by the use of mud bricks bound together by mud plaster and then covered with earthen plaster.

The Great Mosque, located in Djenné, Mali, is one of the largest standing mud brick earthen plaster finish buildings with its original construction dating back to the thirteenth to fourteenth century. The use of earth as a finish material not only provided an ornamental craft but also a ceremonial community-led maintenance activity.

On the commodified side, earth plaster finishes can be derived from clay-rich soils, which are composed of approximately 20% clay minerals. Earth plasters use mix-designs that can range in color and texture, by using natural pigments and additives such as stone powder or mica and have been shown to act as passive removal materials for voltaic organic compounds thus improving the indoor air quality and providing healthy spaces.

Recent product developments have been also using earth material finish applications for smaller-scale tiles, furniture, and finished products. Examples such as terra tiles from Criaterra Innovations use a mechanical process to create tiles that replicate the strength of cement but are made from natural, biodegradable, and recyclable clay-soil materials derived mainly from industrial waste diggings.

Clay-rich soils are composed of a range of particle distribution quality, e.g., from sands, to silts to fine clay particles, that can then be processed via air- or sun-drying mechanisms. When these earthen materials dry, they can be broken down with the addition of water. As a widely available resource that can be used in a reversible metamorphosis, raw earthen materials thus pose a future for sustainable material design and development in a range of design disciplines.

Unique among smaller-scale design applications of raw earthen materials is mud fabric dyeing. One such technique is Dorozome, a dyeing technique original to Amami Oshima, Japan, where the local kimono cloths are pigmented by soaking the fabric in mud baths or muddy rice fields.

Meanwhile, the process of creating Malian mud cloth, or bogolanfini, involves paint-dyeing mud onto textiles traditionally done by Bamana women artists, with its technology tracing back to the 12th century. The fabrics are first soaked or boiled in water containing the leaves and branches of two different tree varieties: N'Galaman (Anogeissus leiocarpus) and N′T-jankara (Combretum glutinosum). Afterward, the fabric is sun-dried and treated with mud paint, which is made by mixing iron-rich mud sourced from local ponds with water. The mud paint uses a fermentation process that can last up to a year before it is ready for use.

Textiles are materials made of natural or synthetic fibers that conjoin through methods of weaving, knitting, felting, etc. The textile industry is a major contributor to significant carbon dioxide emissions and environmental pollution. Accounting for over 10% of global emissions annually (equivalent to 1.2 billion tons of CO₂), the textile sector surpassed the combined emissions of aviation and shipping industries in 2018. With about 60% of textile production allocated to clothing, the fashion sector remains a primary driver of the industry's carbon footprint. Textiles, which are often referred to as fabrics in the context of the fashion industry, often have fibers that are synthetic. Synthetic fibers, predominantly polyester derived from petroleum oil, constitute over two-thirds of textile fibers. Thus, the textile industry's contribution to climate change poses a serious concern if current industrial practices persist.

Furthermore, the textile industry's environmental impact extends beyond carbon emission output. It also contributes to substantial environmental waste and pollution. The textile industry is estimated to produce 93 billion cubic meters of water annually with industrial dyeing and finishing processes alone contributing to nearly 20% of all industrial wastewater pollution. In 2015, more than 70% of textiles ended up in a landfill or were incinerated with less than 1% of materials used to produce clothing being recycled back into the production of new clothing.

One prominent solution to the environmental concerns related to the textile industry is the creation and use of alternative bio-based textiles that are biodegradable, recyclable and resource efficient for garment and architectural applications. Emerging bio-based textile technologies such as brewing symbiotic culture of bacteria and yeast into fabric, transforming cactus waste into alternative leathers and brewing recombinant structural proteins into biodegradable fabrics pose as examples of the possibility of using alternative bio-based material technologies as a textile environmental solution.

Despite the significance of the above traditional techniques, raw earthen materials and their applications in fabric construction are not prevalent in contemporary design explorations given the initial functional restraints that Earthen materials postulate. As earthen materials dry, questions emerge regarding the material's affordance of flexibility through mobility. Additionally, challenges related to lending particles, and the weight, volume and strength of earthen material mixtures can dictate the usability of these materials within this design application. Therefore, additional demonstration and experimentation into earth materials and their ability to be integrated into textile design for expanded wearable and architectural elements is desired.

### SUMMARY

Aspects of the present disclosure are directed wearable textiles. In some embodiments, the wearable textiles include one or more earth-based materials including clay-rich raw soil; one or more bio-based polymers; and one or more fiber additives integrated with the earth-based materials, the bio-based polymers, or combinations thereof. In some embodiments, the wearable textiles include about 65% by weight clay-rich raw soil. In some embodiments, the bio-based polymers include cornstarch, glycerin, cellulose, gelatin, alginate, agar, or combinations thereof. In some embodiments, the fiber additives include wheat straw, paper waste, or combinations thereof. In some embodiments, the textiles have an average thickness between about 0.1 cm and about 2 cm in thickness.

Aspects of the present disclosure are directed to a method of making a wearable textile. In some embodiments, the method includes forming a mixture including one or more earth-based materials including clay-rich raw soil; one or more bio-based polymers; one or more fiber additives; and one or more fluids. In some embodiments, the method includes heating the mixture to a temperature above about 150° C.; stirring the mixture; casting the mixture to one or more molds formed consistent with a desired shape of the wearable textile; and curing the mixture. In some embodiments, the fluids include water, vinegar, or combinations thereof. In some embodiments, the mixture includes the following solids vol. %: about 25% fiber additives, and about 28% earth-based materials to bio-based polymers. In some embodiments, heating the mixture includes heating the mixture to a temperature between about 162° C. to about 176° C. for about 10 minutes.

Aspects of the present disclosure are directed to a garment including the wearable textiles discussed above. In some embodiments, the garments include one or more textile pieces including one or more earth-based materials including clay-rich raw soil; one or more bio-based polymers; and one or more fiber additives integrated with the earth-based materials, the bio-based polymers, or combinations thereof. In some embodiments, the textile includes about 65% clay-rich raw soil. In some embodiments, the average thickness of the one or more pieces of textile is between about 0.1 cm and about 2 cm in thickness.

In some embodiments, the garment is composed entirely of textile pieces. In some embodiments, the garment includes one or more fasteners. In some embodiments, other than the one or more fasteners, the garment is composed entirely of textile pieces.

In some embodiments, the garment is constructed via a laser-cutting, an embroidery process, a machine sewing process, or combinations thereof. In some embodiments, the garment is constructed via a method including stitching together adjacent textile pieces via a needle, wherein fabric strips are positioned between the textile pieces and a point of the needle during the stitching.

Exemplary embodiments of the fabric of the present disclosure find application in a series of designs, delving into its utilization within the realm of fashion design. These exemplary embodiments combine material science and engineering with fashion design and architectural practices while offering biomaterials in an effort to shift towards a more circular material paradigm.

In some embodiments, the flexible soil-based fabric includes only naturally occurring substances, as opposed to other bioplastics that use synthesized materials. In some embodiments, the main ingredient in in this fabric is raw soil which is environmentally contributional due to its non-toxicity, minimal processing, and low impact characteristics.

The successful resulting mix designs were added with and without fibers, and were tested for their tearing strength and microstructural composition. Without wishing to be bound by theory, the analysis results reveal that material mix designs containing fiber reinforcement perform better in tearing testing strength capacities than those without fibers. Moreover, tearing test results demonstrated that fabrics with fiber reinforcement had higher peak force loads, with more force to tear at various crosshead points than the fabric samples without fiber aggregates.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 shows images of flexible soil-based wearable textiles according to embodiments of the present disclosure;

FIG. 2 is a chart of a method making a wearable textile according to embodiments of the present disclosure;

FIG. 3A-3E show images of garments composed of wearable textiles according to embodiments of the present disclosure;

FIG. 4 shows images of a process of constructing a garment from wearable textiles according to embodiments of the present disclosure;

FIG. 5 shows images of machine sewing tests incorporating wearable textiles according to embodiments of the present disclosure;

FIG. 6 shows images of embroidery and laser-cutting tests incorporating wearable textiles according to embodiments of the present disclosure;

FIG. 7 shows a qualitative index of experiments developing wearable textiles according to embodiments of the present disclosure; and

FIG. 8 shows scanning electron microscopy images of wearable textiles according to embodiments of the present disclosure.

### DETAILED DESCRIPTION

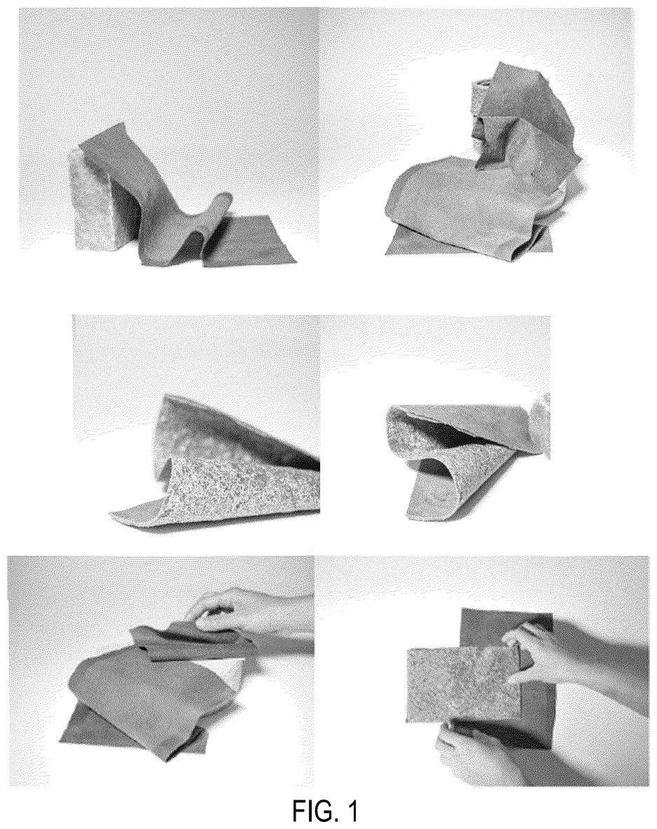

Referring now to FIG. 1, some embodiments are directed to a wearable textile. In some embodiments, the wearable textile includes one or more earth-based materials. In some embodiments, the earth-based materials include raw soils. In some embodiments, the earth-based materials include clay-rich raw soil. In some embodiments, the wearable textiles include about 65% by weight raw soil, e.g., clay-rich raw soil. In some embodiments, the clay-rich soil has above about 20% clay. In some embodiments, the clay-rich soil includes above about 25% clay. In some embodiments, the clay-rich soil has above about 30% clay. In some embodiments, the clay-rich soil has above about 35% clay. In some embodiments, the clay-rich soil has above about 40% clay. In some embodiments, the clay-rich soil has above about 45% clay. In some embodiments, the clay-rich soil has above about 50% clay.

In some embodiments, the wearable textile includes one or more bio-based materials. In some embodiments, the bio-based materials include bio-based plastics or biopolymers. In some embodiments, the biopolymers include bio-based, food-grade polysaccharides. In some embodiments, the biopolymers include cornstarch, glycerin, cellulose, gelatin, alginate, agar, or combinations thereof. In some embodiments, the wearable textiles are composed only of earth-based materials and bio-based materials. In some embodiments, the wearable textiles are composed only of earth-based materials and bio-based polymers. In some embodiments, the wearable textiles are composed only of clay-rich soil and bio-based polymers. As used herein, one of ordinary skill would understand that wearable textiles “composed only” and the like of certain components can also include trace amounts of other materials, e.g., various impurities, moisture content, etc., without deviating from the embodiments of the wearable textiles as described in the present disclosure.

In some embodiments, the wearable textile includes one or more fiber additives. In some embodiments, the fiber additives are integrated with the earth-based materials, the bio-based polymers, or combinations thereof. In some embodiments, incorporating fibers into earth-bioplastic mix-design recipes is used to adjust the microstructural and bond structures, enhancing the strength of the fabrics.

In some embodiments, the fiber additives include wheat straw, paper waste, or combinations thereof. In some embodiments, the wearable textiles are composed only of earth-based materials, bio-based materials, and fiber additives. In some embodiments, the wearable textiles are composed only of earth-based materials, bio-based polymers, and fiber additives. In some embodiments, the wearable textiles are composed only of clay-rich soil, bio-based polymers, and fiber additives.

In some embodiments, the textiles include one or more additional additives, e.g., aggregates, minerals, silt, sand, other inerts, or combinations thereof.

In some embodiments, the textiles are between about 0.1 cm and about 2 cm in thickness. The materials consistent with embodiments of the present disclosure can maintain a fabric-like quality in visual quality and final textile outcomes, and is thus referred to as fabric as such. Wearable textiles consistent with embodiments of the present disclosure can be fashioned into flexible, lightweight, and/or biodegradable fabrics for construction of garments. These materials can undergo a biodegradation process under particular composting and recycling conditions to ensure full biodegradation of materials. The use of food-grade ingredients lowers carbon dioxide gas emissions through reduced fossil fuel use.

Some embodiments of the embodiments are directed to a garment constructed of earth-based materials and bio-based materials. Some embodiments of the embodiments are directed to a garment constructed with wearable textiles. In some embodiments, the garment includes one or more textile pieces. In some embodiments, as discussed above, the textile pieces include one or more earth-based materials. In some embodiments, the earth-based materials include raw soils. In some embodiments, the earth-based materials include clay-rich raw soil. In some embodiments, the textile pieces include about 65% by weight raw soil, e.g., clay-rich raw soil. In some embodiments, the textile pieces include one or more bio-based materials. In some embodiments, the bio-based materials include one or more bio-based plastics or biopolymers. In some embodiments, the biopolymers include bio-based, food-grade polysaccharides. In some embodiments, the biopolymers include cornstarch, glycerin, cellulose, gelatin, alginate, agar, or combinations thereof. In some embodiments, the wearable textiles include one or more fiber additives. In some embodiments, the fiber additives are integrated with the earth-based materials, the bio-based polymers, or combinations thereof. In some embodiments, the fiber additives include wheat straw, paper waste, or combinations thereof.

In some embodiments, the garment is composed of a plurality of connected textile pieces. In some embodiments, the garment is constructed via a laser-cutting, an embroidery process, a machine sewing process, or combinations thereof. In some embodiments, the textile pieces are stitched together, glued together, or combinations thereof. In some embodiments, the textile pieces of the garment include one more reinforcing fabric pieces, e.g., strips, to help connect adjacent textile pieces. In some embodiments, adjacent textile pieces are stitched together via a needle, with fabric strips positioned between the textile pieces and a point of the needle during the stitching, as will be discussed in greater detail below.

In some embodiments, the garment is composed entirely of wearable textiles, e.g., textile pieces. In some embodiments, the garment includes one or more fasteners. The fasteners can include any suitable fastening mechanism or combinations of mechanisms to secure the garment to, on, or about a wearer, e.g., straps, buttons, loops, zippers, etc. In some embodiments, other than the one or more fasteners, the garment is composed entirely of textile pieces. As used herein, one of ordinary skill would understand that a garment “composed entirely” and the like of wearable textile can also include components that hold adjacent textile pieces together, e.g., threads, adhesives, etc., as well as aesthetic features, e.g., decorative embroidery, patches, dyes, paints, etc., without deviating from the embodiments of the garments as described in the present disclosure.

The garment is shaped to provide coverage to a portion of the wearers body of which coverage is desired and take the form of any traditional article of clothing, e.g., a shirt, blouse, kimono, wrap, etc., and have any desired structural features thereof, e.g., sleeves, backs, collars, pockets, vents, slits, etc. In some embodiments, the average thickness of the one or more pieces of textile in the garment is between about 0.1 cm and about 2 cm in thickness.

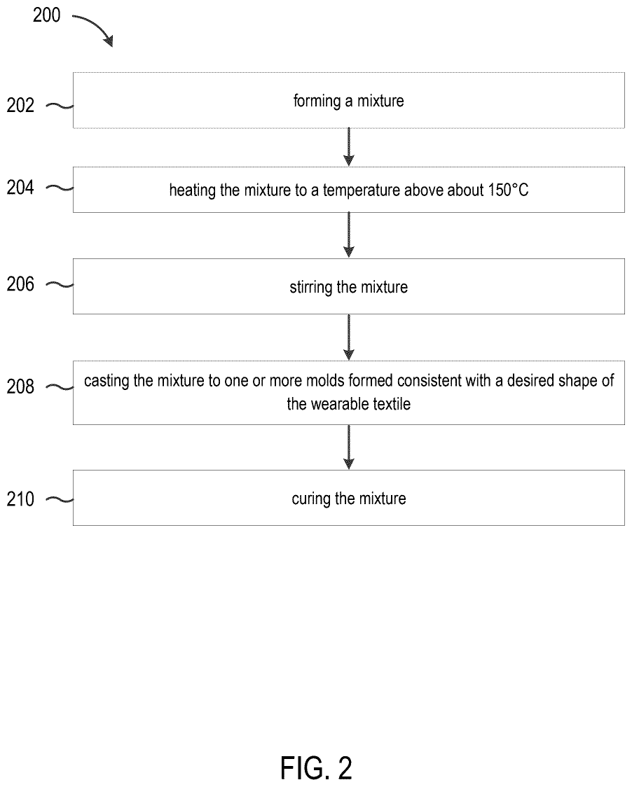

Referring now to FIG. 2, some embodiments of the present disclosure are directed to a method 200 of making a wearable textile. At 202, a mixture is formed. In some embodiments, the mixture formed at 202 includes one or more earth-based materials. As discussed above, in some embodiments, the earth-based materials include raw soils. In some embodiments, the earth-based materials include clay-rich raw soil. In some embodiments, the mixture formed at 202 includes one or more bio-based materials. As discussed above, in some embodiments, the bio-based materials include one or more bio-based plastics or biopolymers. In some embodiments, the biopolymers include bio-based, food-grade polysaccharides. In some embodiments, the biopolymers include cornstarch, glycerin, cellulose, gelatin, alginate, agar, or combinations thereof. In some embodiments, the mixture formed at 202 includes one or more fiber additives. As discussed above, in some embodiments, the fiber additives include wheat straw, paper waste, or combinations thereof. In some embodiments, the mixture formed at 202 includes one or more fluids. In some embodiments, the fluids include water, vinegar, or combinations thereof. In some embodiments, the mixture includes about 25 solids vol. % fiber additives. In some embodiments, about 28 solids vol. % earth-based materials to bio-based polymers.

In some embodiments, the mixture is formed 202 by adding the dry ingredients to the fluid for uniform or substantially uniform distribution. In some embodiments, forming 202 includes dry mixing the earth-based materials and the bio-based materials to form an initial mixture and adding the fiber additives and the fluids to the initial mixture to form the mixture.

In some embodiments, at 204, the mixture is heated. In some embodiments, the mixture is brought to an elevated temperature for a predetermined amount of time. The mixture can be heated by any suitable mechanism or combination of mechanisms, e.g., via position on a hot plate, in an oven, etc. In some embodiments, the mixture is heated 204 to a temperature above about 150° C. In some embodiments, the mixture is heated 204 to a temperature between about 160° C. and about 180° C. In some embodiments, the mixture is heated 204 to a temperature between about 162° C. and about 176° C. In some embodiments, the mixture is heated 204 for more than 5 minutes, 10 minutes, 15 minutes, etc. In some embodiments, the mixture is heated 204 for about 10 minutes.

In some embodiments, at 206, the mixture is stirred. In some embodiments, the mixture is stirred during heating 204, after heating 204, or combinations thereof. In some embodiments, the mixture is stirred 204 continuously or semi-continuously.

In some embodiments, at 208, the mixture is cast. In some embodiments, the mixture is cast 208 into one or more molds. In some embodiments, the molds are formed consistent with a desired shape of the wearable textile, e.g., a structural component of a garment, a whole garment, a flat sheet for subsequent use in garment construction, etc. In some embodiments, the molds are made of plaster, silicone, etc., or combinations thereof.

In some embodiments, at 210, the mixture is cured. In some embodiments, the mixture is cured for a desired duration. In some embodiments, the mixture is cured 210 for more than 1 day, 2 days, 3 days, 4 days, 5 days, 6 days, 7 days, 2 weeks, etc. Upon curing 210, the wearable textile can be removed from the mold and fashioned into a garment consistent with those discussed above. In some embodiments, the wearable textile formed by method 200 includes about 65% by weight clay-rich raw soil.

Exemplary embodiments of the present disclosure constructed garments, specifically using local clays and bioplastics as the main textile matrix given their local availability, biodegradability and minimal processing characteristics. Earthen materials can include naturally occurring geological substances such as rocks, sand aggregates, clay minerals, silt, and sand. Ceramics can contain fine-grained clay-rich soils that have illite and smectite mixed-layer minerals and water proportions that produce a high-plasticity material, generally known as “clay”, which can then be functionally shaped into a desired form and fired in high-temperature kiln processing. Raw earthen materials can be composed of a combination of clay-rich soil, with wide particle distribution quality, e.g., from sands, to silts to fine clay particles, that are then processed via air- or sun-drying mechanisms. When water is added, the earthen materials become soft and sticky (namely, mud). When these earthen material forms are dry, they can be broken down back into its original composite form with the addition of water alone. Even though clay-rich soils have not been traditionally used for textile production due to their rigid properties, these materials have been historically utilized in a range of architectural, design, and textile applications, including dyeing and treating fabrics with clay-rich soils.

Exemplary embodiments of the present disclosure include mix-designs of bio-based materials; 65% of which is clay-rich raw soil which is integrated with bio-based plastics, e.g., derived from naturally occurring biopolymers. The developed materials were flexible, light, biodegradable and maintained a consistent natural brown hue. These exemplary embodiments were analyzed with a mix-design analysis, using electron microscopy, and a macro-scale structural characterization using tearing tests, as will be discussed in greater detail below. Final demonstrations showcased an array of design applications. Embodiments of the present disclosure address the environmental concerns of the textile industry by material development and innovating the next generation of biomaterials that can redefine our current material paradigm towards a more circular and renewable state.

### EXAMPLES

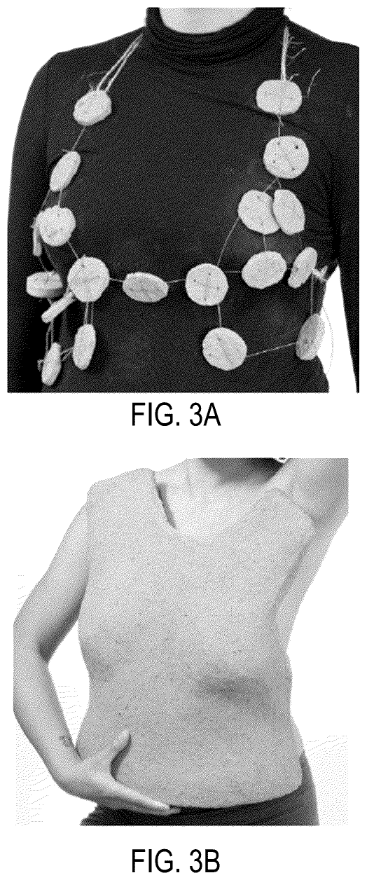

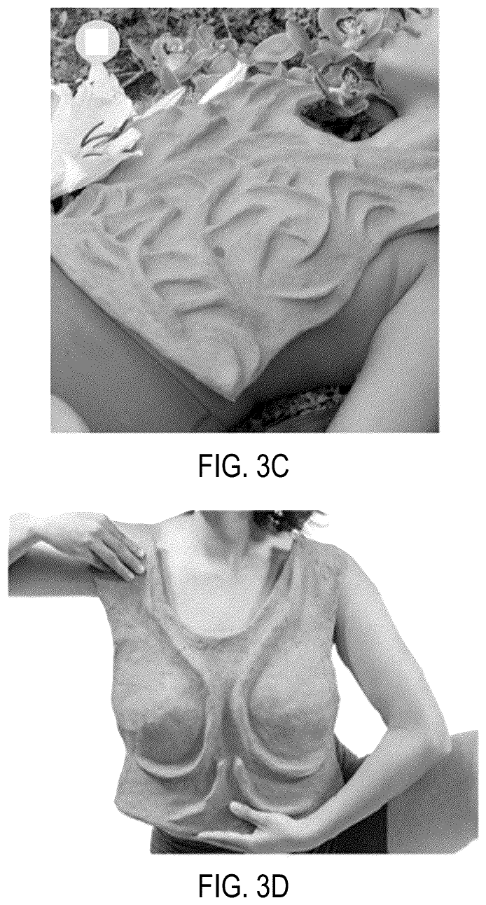

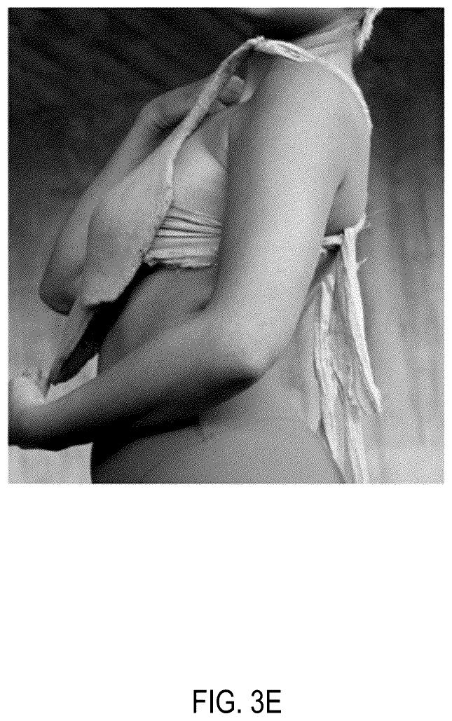

Referring now to FIGS. 3A-3E, rigid garments consistent with some embodiments of the present disclosure were constructed. The exemplary embodiments were composed of four typologies.

Referring specifically to FIG. 3A, in some embodiments, the “Body Tiles” mix-design was prepared that included small circular tiles with holes to allow fibrous supports to be woven between tiles. In some embodiments, the Body Tiles demonstration resembled chainmail and weaving systems that allowed formless structures to be worn and draped onto the body. The final mix was molded into small circular tiles, 3 cm in diameter, and marked with holes at the top and bottom of each tile in order to be threaded with hemp fibers to form a loose shape of a bralette that could be worn to cover the breast area of a torso. The resulting Body Tile garment was extremely lightweight and could be tied onto the body in different variations. However, the garment did not fully cover the body's torso and posed more as a body accessory.

Referring now to FIG. 3B, in some embodiments, the “Thick Skin” mix-design was prepared that incorporated one reinforcing fiber within the final soil composition in an effort to build a more cohesive but structurally sound torso garment. In this embodiment, the recipe for the mix-design of Thick Skin garments incorporated one reinforcing fiber during the processing stage. There was a significant amount of material used in order to achieve the reinforcement for the final garment structure. Once molded and cured, the final garment showcased a garment ranging from 30 cm to 34 cm in width and 40 cm in height and weighed on average 3 kg. The thickness of the Thick Skin garment was 1.5 cm. The Thick Skin garments also underwent the Tadelakt sculpting techniques to attain a smoother appearance. A select few of the Thick Skin garments were further painted with different clay and water solutions in order to create varied color shades for a specific desired aesthetic purpose. The production of Thick Skin garments demonstrated embodiment of wearable soil garments that provided full coverage to a human torso.

Referring now to FIGS. 3C-3D, in some embodiments, the “Ridged Skins” design utilized material to form vertical crests across the garment's face in an effort to enhance the structural integrity of the garment. In some embodiments, the mix-design recipe for Ridged Skins garments incorporated one reinforcing fiber during the processing stage and resulted in a reduced material to structurally reinforce the garment when molded onto the plaster torso. Extra material was then sculpted into vertical crests that were superimposed onto the face of the garment in both vertical and horizontal directions. This three-dimensional layer was added to reinforce the structural quality of the garment to prevent it from cracking and breaking. The Ridged Skins garments were semi-thin with a width of 34 cm and 40 cm in height and thickness of 1.5 cm. The Ridged Skin garment weighed 1.7 kg. In some embodiments, the incorporation of two reinforcing fibers improved the Ridged Skins overall design, which produced lighter garments compared to the Thick Skins predecessor. The sculpted crests that were imposed on the front face of the garment provided an additional layer of protection for the wearer and structurally reinforced it, preventing cracks and breaks during the curing stages which further increased the durability of the garment.

Referring now to FIG. 3E, in some embodiments, the “Thin Skin” mix-design utilized two reinforcing fibers within its soil composition which reduced the need for added structural reinforcement and material. The Thin Skin garments were extremely thin and lightweight, allowing for shoulder strap mechanisms to be incorporated into the final design of the garment. Some embodiments of the Thin Skin garments had fabric sleeves made of the base material that were molded into a shoulder shape. Once cured, the shoulder sleeves could be placed on top of the shoulder of the person wearing the garment and be held up without support from the hands. Some straps were made of the soil material, while others were cotton sleeves that were pasted with “mud glue” onto the thin skin garment's shoulders and back tie points. In some embodiments, this mix-design recipe produced an extremely thin garment, with a thickness of 0.5 cm and an average weight of 1 kg.

From the Thick Skin garments with their heavy weight and smooth appearance to the Thin Skin garments with their strapping mechanisms and reduced weight, the exemplary mix-design recipes allow for greater flexibility and comfort for the wearer. The Ridged Skins garments, with their semi-thin form and sculptural ridges, provide both an aesthetically pleasing design, added protection against wear and tear and structural reinforcement. The Body Tiles represent the lightest iteration of the Rigid Garments, showcasing the range of possibilities that the mix-design recipe offers.

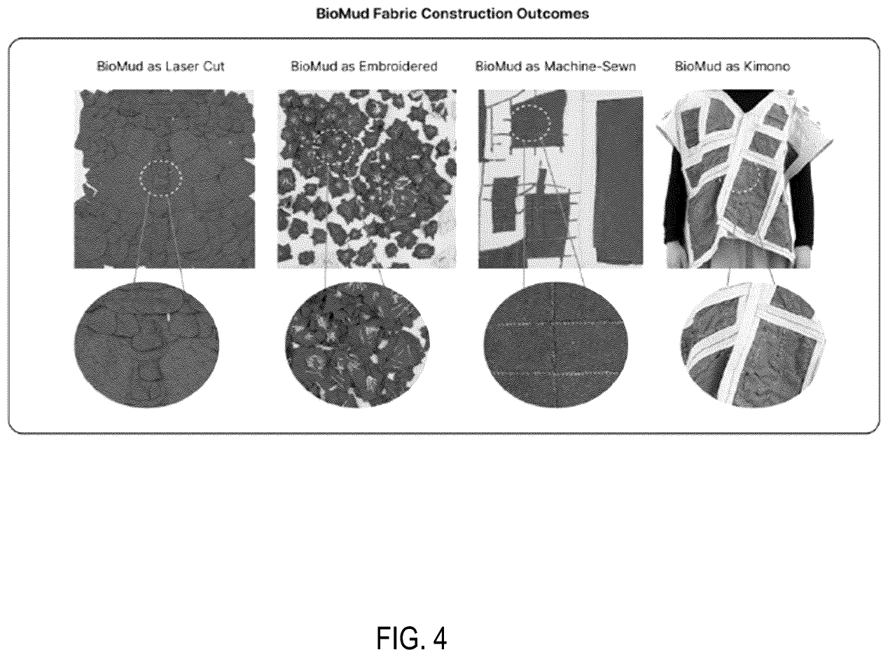

Referring now to FIG. 4, flexible soil fabric was developed and molded into large sheets (290 mm by 220 mm). The utilization of soil fabric sheets in construction was initially executed through machine-sewing techniques.

Smaller samples of the flexible soil fabrics were first tested to identify thread patterns, tensions, and speeds to prevent the fabric from tearing while being sewn. These small patches were sewn with different thread tensions, speeds and shapes, exploring different shapes and methods that would prevent the material from tearing. Small strips of fabric were also placed on the edges of the developed fabric as a direct barrier between the needle point and the fabric itself as an alternative process that could prevent the material from tearing.

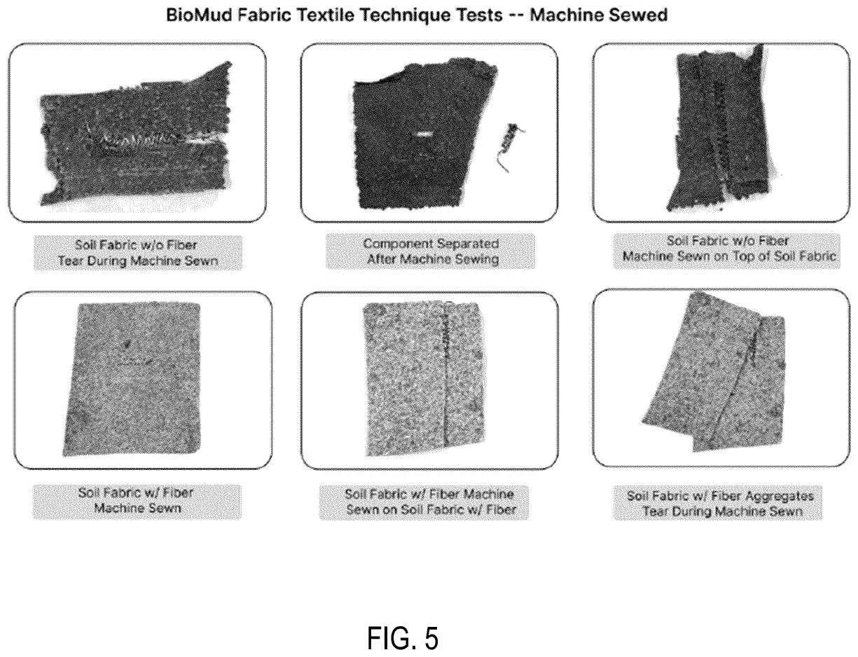

Referring now to FIG. 5, once the speed and tension settings were determined, the soil fabrics were machine sewn onto a natural canvas fabric, and at certain points, additional canvas fabrics were also sewn over the edges of the material to increase its stability and decrease its propensity to tearing.

Referring again to FIG. 4, excess flexible soil fabric scraps were gathered and repurposed for embroidery fabrication techniques. Meticulously layered, the embroidery process enhanced the flexible soil fabric's material stability and strength. The labor-intensive embroidery process extended fabrication time for wearable soil fabric garments made from embroidery and affected the size of the final forms. The flexible soil fabric sheets were also laser-cut into organic shapes. The individually cut pieces were sewn onto canvas fabric and showcased improved durability, reduced weight, enhanced flexibility, and more streamlined fabrication processes.

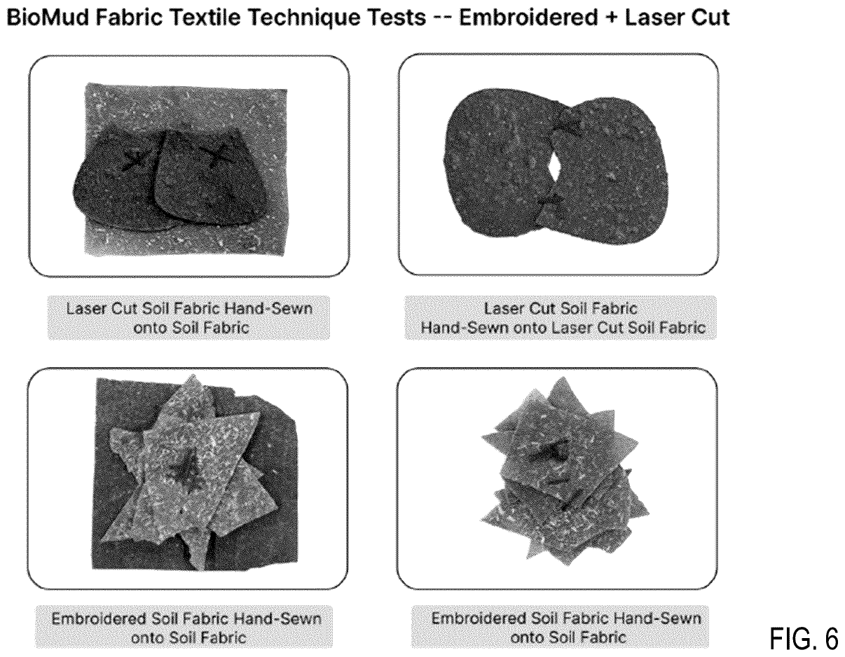

Referring now to FIG. 6, through a meticulous embroidery process, the flexible soil fabric scraps were seamlessly integrated into the canvas fabric, resulting in a display and use of the material. Layering helped to increase the stability and strength of the material which allowed for the soil fabric to be manipulated without fear of tearing and breaking. The size of the embroidered soil fabrics was often from 1.5 cm to 3 cm wide, affecting the final form of the material.

Rhino software was utilized to create scale-like shapes which were then uploaded to ULS Laser Cutter, Model PLS6.75 to precisely cut the flexible fabrics into these shapes. The size and shape of the material lended itself to improved durability found during the final fabrication process of sewing the pieces together given their decrease in weight and geometric benefits. As each piece was laid on top of each other, the final form could take many variations and used one layer of the soil fabric to do so. Furthermore, the final laser-cut flexible soil fabric shapes were sewn onto natural canvas fabric to create a cohesive pattern of the scales, and proved to increase tensile strength and flexibility which afforded an increase range of wearability.

Referring again to FIG. 4, using natural canvas fabric, a garment inspired by a kimono style was created, featuring large sheets of flexible soil fabrics that were molded and cured to measure approximately 29 cm by 22 cm. A patchwork of laser cut construction was followed, with the flexible soil fabrics sewn together to fill in large spaces and in different shapes on the kimono, resulting in complete torso coverage of the garment using flexible soil fabric. The kimono showcased the possibility of the material to be used for garment construction. The process included all three fabrication techniques, applied at relevant construction phases of the garment. This kimono constructed using wearable textiles consistent with embodiments of the present disclosure highlighted the material's flexibility and ability to adapt to the dynamism of human movement.

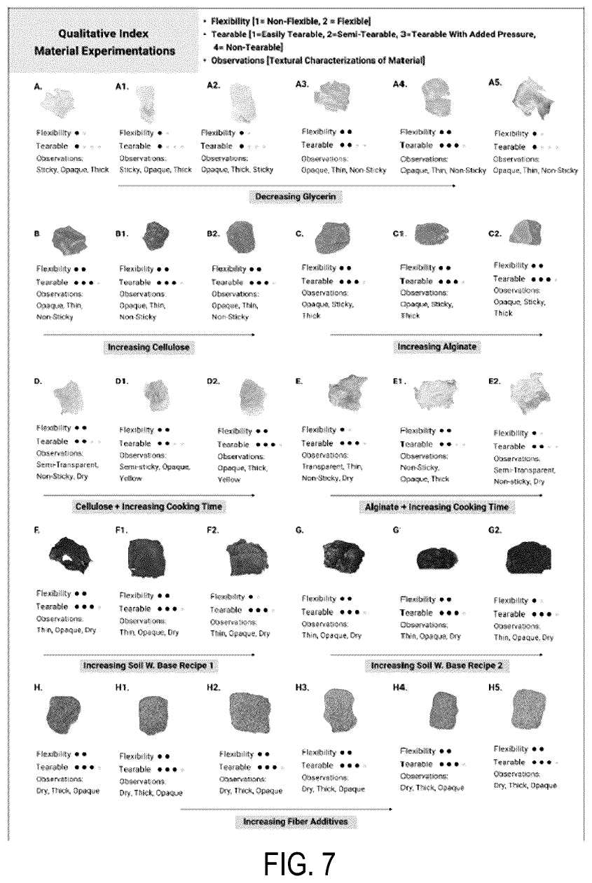

Referring now to FIG. 7, exemplary embodiments of the flexible soil fabric described above underwent both qualitative and quantitative material characterizations. The qualitative assessment was used as an exploratory evaluation to identify mix design. As a qualitative assessment, each fabric was assessed manually to their flexibility, strength, and texture. The fabrics' flexibility was determined by bending the fabric horizontally and assessing its range of motion, scored between 1 (non-flexible) and 2 (flexible). A score of 1 indicated that the fabric was non-flexible, while a score of 2 indicated that it was flexible. Tearing test scores ranged from 1 (easily tearable) to 4 (non-tearable). If the material tore immediately, it was given a score of 1; if it could resist pressure and tore after increased pressure was applied, it was given a score of 3. Finally, the textural quality of the fabrics was qualitatively analyzed by observing their characteristics visually, including wetness versus dryness, stickiness versus smoothness, thickness versus thinness and opaqueness versus translucence.

The recipes shown in FIG. 7 evolved based on an experimentation and evaluation of their qualitative outcomes. For example, in the category of ‘Decreasing Glycerin’ from recipes A-A5, each recipe was iterated based on the changing volume of glycerin in proportion to other base constituents of the recipe design. In this evaluation, high concentrations of glycerin created a biomaterial textile that was wet and failed to solidify. However, too low a concentration of glycerin created a biomaterial textile that was too rigid and was not prone to flexibility that would be needed for wearability. Additional material recipes experimented with different biopolymers, their varying concentrations, and their cooking time to see how these changing variables might also impact the qualitative outcomes of the biomaterials which can be seen in categories of ‘Increasing Cellulose’, ‘Increasing Alginate’, ‘Cellulose+Increasing Cooking Time’, and ‘Alginate+Increasing Cooking Time’. These recipes were iterated incrementally by a specific concentration amount of biopolymer or time change based on a specific controlled percentage change to identify and evaluate differences between the material designs and their qualitative assessments.

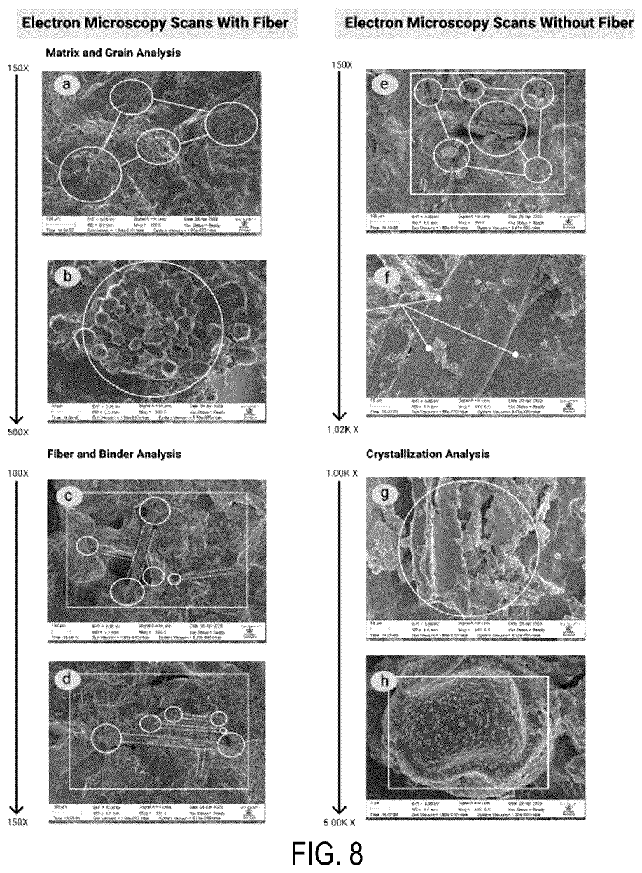

Then, a quantitative evaluation included a microstructural analysis using electron microscopy to reveal its molecular arrangement and matrix quality and a strength tearing characterization test employed by a standard trapezoid procedure using a CRE tensile testing machine (ASTM D5587). Sample specimens of the soil fabrics were cut to standard (150 mm×75 mm) and clamped onto the machine with 50 mm×75 mm hydraulic pneumatic clamping systems. The distance between the clamps at the start of the test was at 25±1 mm (1±0.05 in.) and the testing speed was 300±10 mm (12±0.5 in./min). Referring now to FIG. 8, exemplary embodiments of flexible soil fabrics “With Fiber” were observed with magnifications from 150× to 500× nano millimeters, revealing evenly distributed circle-shaped bulbs in the matrix, likely due to added gelatin and alginate biopolymers (see FIG. 8 at “a” and “b”). Shredded agricultural baste fibers introduced a consistent reinforcement. These fibers formed vertical columns across the matrix gaps, binding and reinforcing the material, potentially enhancing interconnection and strength (see FIG. 8 at “c” and “d”). Observations of exemplary flexible soil fabrics “Without Fiber” spanned magnifications from 150× to 5.00K×, revealing a dense matrix with varied vertical crystallization forms (see FIG. 8 at “e” and “f”). Crystallization forms (see FIG. 8 at “g” and “h”) occurred sporadically throughout, displaying diverse shapes and sizes potentially indicating variable bond cohesion and matrix inconsistency.

The strength tearing test of the fabrics was conducted using a D5587-15 (2019) machine and followed a standard trapezoid procedure using a recording of constant-rate-of-extension-type (CRE) tensile testing machine which is useful for estimating the relative tear resistance of different fabrics. The test measures two strength calculations: the single-peak force and the average of five highest peak forces using standard SI units. The highest peaks reflect the strength of the fabric's components, individually or in combination, to stop a tear. The valleys recorded between the peaks have no specific significance. The minimum tearing force, however, is indicated to be above the lowest valleys. The tearing strength observed using this method used a tear of the fabric samples initiated before testing and can be applied to most fabrics including woven fabrics, air bag fabrics, knitted fabrics and nonwoven fabrics and non-traditional fabrics such as the soil fabric developed.

The ASTM D5587 tearing test results exhibited high variability in force distribution over time for both fabrics: with and without fiber reinforcement. However, fabric with fibers exhibited significantly higher peak loads (4.0N at around 12.4 mm crosshead point) before tearing compared to fiberless samples (2.8N at around 14.2 mm). Quantitative results also revealed that flexible soil fabrics containing fiber aggregates perform better in tearing testing strength capacities than those without fiber in pure force load but not necessarily over a period of time. Therefore, incorporating fibers into flexible soil fabric mix-design recipes can be an aggregate to reinforce the microstructural bonds to enhance the strength of the fabrics in both pure force load and over time. Further, alternative or additional plasticizing materials can be added to enhance flexibility without compromising tensile strength.

A research-by-design methodological approach was performed with a procedure initiated by material selections, material composite processing and applied design demonstration phases: rigid garments and flexible or soil fabrics. Flexible soil fabrics also underwent a material characterization and diagnostics analysis. The materials used to make exemplary embodiments of the present disclosure were selected on the basis of at least three characteristics. First, in some embodiments, the materials were naturally derived or occurring, e.g., the material is naturally found or produced within the natural environment without artificial production. In some embodiments, the material had biodegradability characteristics, e.g., the material could be broken down or decomposed by natural biological processes without causing harm or pollution to the environment. In some embodiments, materials were also selected based on the materials qualities and subsequent interactions, e.g., clay-rich soils integrated with shredded wheat straw.

The selected materials were then further classified into four categories: earthen materials, biopolymers, reinforcing fibers, and fluids based on their qualitative and quantitative material composition properties.

The chosen materials for experimentation included clay-rich soil sourced from Goshen, New York which was characterized by an ASTM standard sedimentation test and then pre-treated using a pre-pottery technique called Terra Sigillata. Biopolymers utilized in the experiment such as cornstarch, glycerin, alginate, cellulose, gelatin, agar were all sourced from Millipore Sigma. Reinforcing fibers included wheat straw, paper waste, and fluids included water and vinegar.

Clay-Rich Soils. The soil used in the research was of a dark gray-brown composition, sourced from a local quarry (Goshen, New York USA). At the quarry, soils are brought from nearby construction sites and other infrastructure excavations. The soils are tested to be clean of contaminants; the term used in the quarry to specify clay-rich subsoil suitable for construction is “clean fill dirt”.

As a first pass test, raw soils were characterized according to the recommended applied testing methods by ASTM and international standard for earthen walls, including the sedimentation test (also known as the shake test), ribbon and ball tests, drop test, and shrinkage test. The sedimentation test provides a first pass quantitative measurement of the fine gravel, sand, silt and clay fractions within an existing soil sample. As part of the test, a loose sample of soil is soaked into water within a transparent container of approximately 500 mL. The container is vigorously shaken for 1-2 minutes, after which it is left undisturbed until the test has been completed. Readings are taken 1 minute after shaking to measure the combined layers of fine gravel and sand, 45 minutes after shaking to measure the combined layers of sand and silt, and 24 hours after shaking to measure the layer of clay. The layers are measured in height as a percentage of total soil height.

The soils were then processed in a pre-pottery technique called Terra Sigillata which uses dry and wet sifting methods. The dry method involves completely drying out the soil, sifting it repeatedly and pounding the mud globs until it's completely uniform and flour-like. The wet sifting method involves adding both water and soil to a container. The soil is then wet stirred using a sifter, then allowed to sit for a brief period to allow the rock, sand, and silt to settle out. The clay stays suspended in the water and then let dry into a powder form.

Biopolymers. Biopolymers were used in the fabric mix-design composition as a bioplastic binder agent. Biopolymers were chosen due to their biodegradable and food compatible characteristics that make them an environmental, economic, and healthy alternative to conventional petroleum-based binders. The biopolymers used in these exemplary embodiments were cornstarch, glycerin, alginate, cellulose, agar and gelatin. The curated selection of biopolymers represents a diverse range of properties, from binding to super plasticizing, and strength reinforcement.

Cornstarch. Cornstarch is produced by processing corn through a wet-mill method. It is a white, odorless macromolecular plant polysaccharide powder that is composed of two homopolysaccharides, amylopectin, 75%, and amylose, 25%. Cornstarch has been used in a variety of industrial applications, especially in the food industry, where it is used as a thickening agent as well as to improve the shelf life of food products.

Glycerin. Glycerin is a transparent, odorless and viscous liquid that contains a three-carbon hydrocarbon with one hydroxyl group attached to each carbon atom. It can be procured through the hydrolysis of fats and mixed oils or the fermentation of yeast, is non-toxic, inhibits the growth of bacteria, and highly soluble in water. The material's properties make it useful as a solvent for the production of products primarily in the cosmetic industry but glycerin can also have similar applications in food and pharmaceutical industries. Glycerin is a material used in bioplastic production because it functions as a plasticizer, helping to soften and increase the flexibility of the mix design.

Sodium Alginate. Sodium alginate is a natural polysaccharide primarily derived from the intracellular matrix of brown algae, but it has also been found from bacterial sources like the mucoid strain P. aeruginosa, which is a soil-dwelling bacteria. Alginate has low-toxicity, water-holding capacities as well as viscosifying and gelatinous properties.

Cellulose. Cellulose is a complex polysaccharide made up of long chains of glucose molecules. It is one of the most abundant biopolymers available in nature because it is found in the fibrillar walls of the majority of plants. From an industrial perspective, cellulose is most commonly found in paper, wood and cosmetic industrial applications. Cellulose largely contributes to the structural maintenance of plant cell walls because its properties allow it to retain the wall even in an aqueous environment which is unusual for polysaccharides in general. This mechanical property makes cellulose a possibility in developing more water-resistant and structural integral bioplastic materials.

Agar. Agar is found in the cell walls of various species of red algae and is a complex polysaccharide composed of repeating units of agarobiose, a disaccharide including D-galactose and 3,6-anhydro-L-galactopyranose. Agar becomes slightly viscous after dissolving in hot water, turning gel-like as the temperature decreases. It is used in the food industry as a thickening agent, stabilizer, and emulsifier due to its gelling properties.

Gelatin. Gelatin is a protein derived from collagen, a fibrous protein found in the connective tissues of animals, such as bones, skin, and cartilage. Gelatin includes a large number of glycine, proline, and 4-hydroxy proline residues and is translucent, colorless, and nearly tasteless powder once extracted and processed. Gelatin is widely used in the food industry as a gelling agent, stabilizer, and thickener due to its texture and functional properties.

Shredded natural bast fibers were added to the mix-design to test their contribution to structural integrity and increased strength of the final material mix-designs.

Wheat Straw. Wheat straw contains the stalk that is left over during the wheat grain harvesting season, making it an agricultural residue or agro-waste. Wheat straw's cellulose-based properties characterize the fiber as being low-density, having high specific strength properties, non-abrasive in nature, and renewable among other effective characteristics that make it have potential for industrial applications. Biomass fibers like wheat straws have been used as a reinforcing material in a growing range of products and applications. Nonetheless, despite the abundance of wheat straw agro waste generated every year, a large percentage of the fiber is still largely unused for industrial applications with a small percentage being used for feedstock and energy production.

Paper Waste. Paper is primarily composed of cellulose fibers obtained from plant sources such as wood, cotton and bamboo which can be further chemically treated to enhance its strength, durability and water resistance properties. Industrially, paper applications are used for printing and writing, packaging, and in hygiene products such as tissues and diapers. The paper industry generates a vast amount of paper product waste, thus recycling paper waste for various industrial uses has the potential to help reduce the environmental impacts of paper production and the amount of waste sent to landfills.

In some exemplary embodiments, the process of creating material compositions for soil fabrics involved manually hand mixing dry ingredients into uniform distribution (which generally took about 2-3 minutes of continuous mixing or when all dry ingredients were visibly combined) while following volume proportional amounts found in the mix-design representations of Table 1 below.

TABLE 1
Mix-design volume proportions of flexible soil fabric

| | | Reinforcing |
|---|---|---|
| Mix-design | Soil to | fibers to soil/ |
| Representation | Biopolymer | biopolymer |
| w/ fiber | 28% | 25% |
| w/o fiber | 28% | 0% |

Reinforcing fibers and fluids were then mixed in for another 2 minutes or until all ingredients were visibly combined. The biopolymer mix designs were cooked at 162° C. to 176° C. for 10 minutes using a 1500 W electric hot plate and manually stirred during the entire duration in order to prevent burning before being shaped into fabric sheets using 27×40 cm silicone mats. These fabrics were cured in an open-air, room temperature (20° C.) space for 5-7 days. For rigid garments, a mold was created by plastering a human torso where soil mix-designs were shaped over and then cured for four days.

In some exemplary embodiments, dry ingredients were first mixed manually to ensure that the components were distributed and uniformly create homogeneously dispersed matter. Sifted clay-rich soils, additives, and reinforcing fibers were combined and stirred using both mechanical agitation and hand mixing methods for a minimum of 5 minutes to ensure that all the composites were fully combined. For the flexible fabrics, some composites were tested with a 10 minute cooking at a temperature range of 162° C. to 176° C., while being continuously stirred to prevent scorching or other heterogeneities that could compromise the quality of the final product.

Upon receiving a uniform mixture, the material was then shaped or pressed into specific form or size using a silicone or otherwise detachable mold. In the creation of the rigid garments, a plaster mold was casted directly on a torso to produce its shape onto which the mixed material was placed. The mixed material was then molded to conform to the shape of the mold through a combination of pressure and sculpting techniques, resulting in a highly accurate and precise final product that resembled a form-fitting armor or second skin. The molding process also incorporated creative design choices for each iteration, such as incorporating ridges inspired by mountainous topographies, to further enhance the form and strength of the material. The time for molding varied depending on the desired form and shape of the garment, with an average completion time of four hours. In the creation of the flexible fabrics, the aqueous substance was poured into a mold constructed of silicone material, which would predetermine its ultimate form and structure. The depth of the silicone molds spanned from 1 mm to 3 mm, while the area occupied by the molds ranged from 22 cm by 15 cm to 30 cm by 22 cm.

The rigid garments took up to four days to fully cure. The flexible/soil fabric material took up to approximately 5-7 days to fully cure, during which time it underwent a significant transformation. As the material dried, it decreased in size and evaporated additional water, resulting in a denser, more compact and cohesive solid structure. Careful monitoring of the curing process was used to avoid structural deficiencies or cracking that could compromise the quality of the final form which yielded a fabric-like substance.

After being fully cured, selected flexible fabrics underwent a qualitative and quantitative evaluation to assess their final flexibility and tear characteristics.

Systems and methods of the present disclosure are advantageous in that they include mix-designs that can be composed entirely of geo- and bio-based materials for the production of sustainable garments. In some embodiments, 65% of the textile used to make the garment is composed of clay-rich raw soil. This clay rich soil is further integrated with bio-based, food-grade polysaccharides and fiber additives to form a wearable garment composed substantially, if not entirely, of natural materials for unparalleled sustainability, as opposed to other bioplastic and petroleum-based additives that use bio-synthesized materials. In some embodiments, locally available clay soils are minimally processed plastic materials that exhibit low-carbon features.

In exemplary embodiments, the soil fabrics were lightweight, including soil fabric without fiber aggregates and with fiber aggregates weighing about 25 grams per square foot and 30 grams per square foot, respectively. Laser cutting, embroidery, and machine sewing techniques can all be employed to directly construct products or integrate the flexible soil fabric into natural canvas fabric for product construction. Overall, the combination of traditional and modern fabrication techniques using the fabric has opened up avenues for incorporating bio-design for fashion and architectural applications. A display of the fabric as a garment, inspired by the traditional Japanese kimono structure, served to illustrate the practical application of the developed fabric in a garment form.

The global response to climate change and its associated negative impacts, such as high carbon emissions, pollution and waste, has prompted a significant shift in the way materials are produced and the ways they relate to their environment. To address this issue, a fabric made of bio-based materials contributes to the growing possibilities of designing with alternative environmentally friendly materials. This biodegradable material emphasizes the rawness of its components and, in some embodiments, integrates bio-based plastics derived from naturally occurring biopolymers and minimally processed soils to create a flexible fabric that can also be used for products beyond apparel, including interiors to food packaging to agriculture, providing a viable alternative to plastic-based fabrics that also promotes social benefits. For example, embodiments of the present disclosure can address large-scale nano plastic contamination in agricultural production from plastic mulch films by serving as a compostable film replacement.

From an environmental perspective, the flexible soil fabric can strictly use naturally derived substances, as opposed to other bioplastic additives that use bio-synthesized materials. The main composite, raw soil, also creates a local supply chain of the material and its subsequent processing methods can be sourced locally and in any geographic, topographic region. This open-source access point for material development and textile application has the potential to address proximal social concerns associated with textile development such as labor concerns across the supply chain, colonial resource extraction, and resource pollution. The sourcing of the materials, especially when considered to be at the local context, has a decarbonized approach to material and fabric development for wearables, design and architectural applications. Additionally, the biodegradability of biobased bio-polymers as integrated in soil as a fabric can be composted and/or buried back into soil for quicker biodegradation and may not harm the ecological systems it's being integrated within. This is especially true when comparing the environmental impacts of plastics which can take up to 300 years to fully biodegrade, and which leaves excessive microplastic run-off in both terrestrial and aquatic environments.

The flexible soil fabrics' main composite of raw soil contains bacteria that are beneficial for human health. Research shows that exposure to friendly soil microbes can help to improve mood regulation, the gut microbiota of humans as well as to improve the tolerance of the human's immune system to decrease allergen risks. Increased access to soils provides biorepository services, functioning as a source of antibiotic-producing organisms, that impact health, safety and comfort. Raw soils can provide bioremediation services, helping to decontaminate toxic waste and pathogens using its microbiota compositions, providing direct benefits and interactions with positive human impact, e.g., long-term impacts on human emotional wellness and psychological, gut well-being. Soils also provide both cultural and aesthetic services, helping to create site-specific maintenance of land that can further promote community terriers that affect the physical and mental states of people and by creating an aesthetically pleasing environment to exist in—or wear.

The flexible soil fabrics also incorporate the deep seeded knowledge imbued within the Earth to inform a contemporary relationship with the natural environment, bringing soils close to the human form and simultaneously reviving our relations to the symbiotic management of Earth resources, and by extension, to one another. The reconnection of the human form through soil wearability and embodiment inspires a deeper and more mindful remembrance of the soil in which we are birthed from to then, the maintenance of the soil in which we need to survive.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A wearable textile, comprising:
one or more earth-based materials including clay-rich raw soil;
one or more bio-based polymers; and
one or more fiber additives integrated with the earth-based materials, the bio-based polymers, or combinations thereof,
wherein the textile includes about 65% by weight clay-rich raw soil.

2. The textile according to claim 1, wherein the bio-based polymers include cornstarch, glycerin, cellulose, gelatin, alginate, agar, or combinations thereof.

3. The textile according to claim 1, wherein the fiber additives include wheat straw, paper waste, or combinations thereof.

4. The textile according to claim 1, wherein the textiles have an average thickness between about 0.1 cm and about 2 cm in thickness.

5. A method of making a wearable textile, comprising:
forming a mixture including:
one or more earth-based materials including clay-rich raw soil;
one or more bio-based polymers;
one or more fiber additives; and
one or more fluids,
heating the mixture to a temperature above about 150° C.;
stirring the mixture;
casting the mixture to one or more molds formed consistent with a desired shape of the wearable textile; and
curing the mixture.

6. The method according to claim 5, wherein the wearable textile includes about 65% by weight clay-rich raw soil.

7. The method according to claim 5, wherein the bio-based polymers include cornstarch, glycerin, cellulose, gelatin, alginate, agar, or combinations thereof.

8. The method according to claim 5, wherein the fiber additives include wheat straw, paper waste, or combinations thereof.

9. The method according to claim 5, wherein the fluids include water, vinegar, or combinations thereof.

10. The method according to claim 5, wherein the mixture includes the following solids vol. %:
about 25% fiber additives, and
about 28% earth-based materials to bio-based polymers.

11. The method according to claim 5, wherein heating the mixture includes:
heating the mixture to a temperature between about 162° C. to about 176° C. for about 10 minutes.

12. A garment, comprising:
one or more textile pieces, the textile pieces including:
one or more earth-based materials including clay-rich raw soil;
one or more bio-based polymers; and
one or more fiber additives integrated with the earth-based materials, the bio-based polymers, or combinations thereof,
wherein the textile includes about 65% clay-rich raw soil.

13. The garment according to claim 12, wherein the bio-based polymers include cornstarch, glycerin, cellulose, gelatin, alginate, agar, or combinations thereof.

14. The garment according to claim 12, wherein the fiber additives include wheat straw, paper waste, or combinations thereof.

15. The garment according to claim 12, wherein the garment is composed entirely of textile pieces.

16. The garment according to claim 12, further comprising one or more fasteners, wherein other than the one or more fasteners, the garment is composed entirely of textile pieces.

17. The garment according to claim 12, wherein the average thickness of the one or more pieces of textile is between about 0.1 cm and about 2 cm in thickness.

18. The garment according to claim 12, wherein the garment is constructed via a laser-cutting, an embroidery process, a machine sewing process, or combinations thereof.

19. The garment according to claim 12, wherein the garment is constructed via a method including:
stitching together adjacent textile pieces via a needle, wherein fabric strips are positioned between the textile pieces and a point of the needle during the stitching.

20. The garment according to claim 12, wherein the garment is constructed via a method including:
forming a mixture including:
clay-rich raw soil;
one or more bio-based polymers including cornstarch, glycerin, cellulose, gelatin, alginate, agar, or combinations thereof;
one or more fiber additives including wheat straw, paper waste, or combinations thereof; and
one or more fluids including water, vinegar, or combinations thereof,
heating the mixture to a temperature between about 162° C. to about 176° C.;
stirring the mixture;
casting the mixture to one or more molds, the molds being shaped to produce textile pieces configured to form structural features of the garment; and
curing the mixture.
